(19) United States
(12) Patent Application Publication
(10) Pub. No.: US 2003/0139145 A1
(43) Pub. Date: Jul. 24, 2003

(54) Data transmitting method and apparatus for guaranteeing quality of service in a data communication system

(75) Inventors: Sung-Won Lee, Songnam-shi (KR); Young-Ky Kim, Seoul (KR); Dong-Soo Park, Seoul (KR); Dong-Jun Lee, Songnam-shi (KR); Sang-Soo Kim, Songnam-shi (KR); Jin-Sung Cho, Yongin-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-do (KR)

(21) Appl. No.: 10/305,561

(22) Filed: Nov. 27, 2002

(30) Foreign Application Priority Data
Nov. 28, 2001 (KR) P2001-74698

(51) Int. Cl. H04B 7/00

(52) U.S. Cl. 455/69; 455/68

(57) ABSTRACT

A data transmitting method and apparatus with QoS guaranteed in a communication system supporting services with different QoS requirements. The services are classified into a QoS service and a non-QoS service and discriminately processed according to the classification. To maximize the efficiency of transmission links, the data rate of a service is dynamically controlled according to the state of the transmission links. Furthermore, the transmission links are prioritized to guarantee the quality of the QoS service even when data congestion occurs and data burstness is regulated to minimize a congestion period during data transmission. Therefore, QoS guarantee is maximized according to services in a communication system supporting data service.

### PRIORITY

This application claims priority to an application entitled “Data Transmitting Method and Apparatus for Guaranteeing Quality of Service in a Data Communication System” filed in the Korean Industrial Property Office on Nov. 28, 2001 and assigned Ser. No. 2001-74698, the contents of which are hereby incorporated by reference.

### BACKGROUND OF THE INVENTION

1. Field of the Invention

The present invention relates generally to a communication system supporting data service, and in particular, to a method and apparatus for transmitting data with QoS (Quality of Service) guaranteed for services with different priority levels.

2. Description of the Related Art

In general, mobile communications system, such as CDMA2000 (Code Division Multiple Access 2000), WCDMA/UMTS (Wideband Code Division Multiple Access/Universal Mobile Telecommunications System), GPRS (General Packet Radio Service), and CDMA2000 1×EV-DO (Evolution-Data Only), include a BSC (Base Station Controller), a BTS (Base Transceiver Subsystem), and an MS (Mobile Station. The BSC is connected to the BTS by cable and the BTS is connected wirelessly to the MS. This mobile communication system typically supports voice service only. Recently, mobile communication systems have been developed to additionally provide data services. Data services include VOD (Video On-Demand), AOD (Audio On-Demand), web browsing, and file transfers.

A typical mobile communication system provides voice service with the same quality to all mobile subscribers. In more recently developed mobile communication systems, however, it is expected that more services will be provided to users paying a high rate and less services to users paying a low rate. In addition, providing the same service with different QoS is under consideration. That is, mobile service providers have built systems to provide multimedia service including voice and data service to subscribers. They classify the subscribers and consider differentiating the number of services provided and QoS for each class. Therefore, there is a need for guaranteeing a corresponding QoS for each service, or if it is impossible, for guaranteeing QoS for a high-priority service in a mobile communication system supporting multimedia service.

Existing mobile communication systems simply have a transmitter for transmitting data (e.g., a packet or ATM cell) via a transmission link connected for a corresponding service and a receiver for receiving the data from the transmission link and transferring it to a higher layer transparently. Accordingly, they have the following problems.

(1) There is no particular operation for QoS guarantee with the mobile communication systems. Therefore, QoS is not defined for all data services and it is impossible to differentiate services. That is, QoS required for each service is not satisfied in a radio link or within the systems.

(2) Due to the impossibility of supporting QoS, if congestion occurs in the systems, data transmission is delayed and data is lost.

(3) Data may be concentrated instantaneously on the transmission link between the BSC and the BTS. Specifically, a high-rate data service may experience instantaneous concentration of a large volume of data in view of its relatively high data burstness. However, a transmitter transmits data to the transmission link immediately after the data is generated, regardless of the state of the transmission link (i.e., data congestion), which leads to great data loss when data congestion occurs.

### SUMMARY OF THE INVENTION

It is, therefore, an object of the present invention to provide a method and apparatus for guaranteeing QoS for each service in a communication system supporting data service.

It is another object of the present invention to provide a method and apparatus for guaranteeing QoS for each service even when data congestion occurs in a communication system supporting data service.

It is a further object of the present invention to provide a method and apparatus for preventing transmission delay and data loss in a BSC and a BTS in a mobile communication system.

It is still another object of the present invention to provide a method and apparatus for preventing data loss caused by instantaneous data congestion at a transmission link between a BSC and a BTS in a mobile communication system.

To achieve the above and other objects, there are provided a data transmitting method and apparatus with QoS guaranteed in a communication system supporting services with different QoS requirements. The services are classified into a QoS service and a non-QoS service and discriminately processed according to the classification. To maximize the efficiency of transmission links, the data rate of a service is dynamically controlled according to the state of the transmission links. Furthermore, the transmission links are prioritized to guarantee the quality of the QoS service even when data congestion occurs and data burstness is regulated to minimize a congestion period during data transmission. Therefore, QoS guarantee is maximized according to services in a communication system supporting data service.

According to one aspect of the present invention, in a data transmitting method for guaranteeing a QoS of a first service in a transmitting apparatus of a communication system in which the transmitting apparatus transmits a data for a first service and a data for a second service having a lower priority than the first service and a receiving apparatus receives the data from the transmitting apparatus, the data rate of the first service for a first period is decreased by a first predetermined value upon receipt of a Congestion Indication Message requesting data congestion control from the receiving apparatus. The data for the first service is transmitted during a second period at the decreased data rate, if the decreased data rate is greater than a predetermined required minimum rate, and at the required minimum rate, if the decreased data rate is equal to or less than the required minimum rate.

It is preferred that the transmitted data is RLP (Radio Link Protocol) packet data.

Also, it is preferred that RLP packet data is segmented into a plurality of transport units of a predetermined size and each of the transport units is transmitted at a predetermined interval.

Further, it is preferred that the transport unit is an ATM cell.

According to another aspect of the present invention, in a data transmitting method for guaranteeing a QoS of a first service in a transmitting apparatus of a communication system in which the transmitting apparatus transmits a data for a first service and a data for a second service having a lower priority than the first service and a receiving apparatus receives the data from the transmitting apparatus, an initial data rate of the first service is set to a minimum rate required for the QoS of the first service and transmitting data for the first service at the set initial data rate during an initial transmission period. The initial data rate of the first service is increased by a first predetermined value and transmitting data for the first service at the increased data rate during a first transmission period a predetermined time after the initial transmission period. Upon receipt of a Congestion Indication Message requesting data congestion control from the receiving apparatus, the increased data rate is decreased by a second predetermined value and data for the first service is transmitted at the decreased data rate or the minimum rate during a second transmission period.

To transmit the data during the second transmission period, the increased data rate is decreased by the second value. The decreased data rate is compared with the minimum rate. If the decreased data rate is greater than the minimum rate, the data for the first service is transmitted at the decreased data rate. If the decreased data rate is equal to or less than the minimum rate, the data for the first service is transmitted at the minimum rate.

It is preferred that the transmitted data is RLP packet data.

Also, it is preferred that RLP packet data is segmented into a plurality of transport units of a predetermined size and each of the transport units is transmitted at a predetermined interval.

Further, it is preferred that the transport unit is an ATM cell.

### BRIEF DESCRIPTION OF THE DRAWINGS

The above and other objects, features, and advantages of the present invention will become more apparent from the following detailed description when taken in conjunction with the accompanying drawings in which:

FIG. 1 illustrates a mobile communication system to which the present invention is applied;

FIG. 2 is a block diagram of the BSC illustrated in FIG. 1;

FIG. 3 is a block diagram of the BTS illustrated in FIG. 1;

FIG. 4 is a block diagram of the channel card illustrated in FIG. 3;

FIG. 5 illustrates a layered protocol structure between a transmitting apparatus and a receiving apparatus in a communication system according to an embodiment of the present invention;

FIGS. 6A, 6B, and 6C illustrate examples of links between the transmitting apparatus and the receiving apparatus illustrated in FIG. 5;

FIG. 7 is a block diagram of a transmitting apparatus according to the embodiment of the present invention;

FIG. 8 is a flowchart illustrating a dynamic rate control operation according to the embodiment of the present invention;

FIG. 9 depicts a data rate control for a non-QoS service according to the embodiment of the present invention;

FIG. 10 depicts a data rate control for a QoS service according to the embodiment of the present invention;

FIG. 11 is a flowchart illustrating an initial operation in the communication system according to the embodiment of the present invention;

FIG. 12 is a flowchart illustrating an operation for generating a Congestion Indication Message in a receiving apparatus in the communication system according to the embodiment the present invention;

FIG. 13 is a flowchart illustrating an initial data transmitting operation in the transmitting apparatus in the communication system according to the embodiment the present invention;

FIG. 14 is a flowchart illustrating a data rate control operation for a QoS service in the transmitting apparatus of the communication system according to the embodiment the present invention;

FIG. 15 is a flowchart illustrating a data rate control operation for a non-QoS service in the transmitting apparatus of the communication system according to the embodiment the present invention; and

FIG. 16 depicts a burstness regulation for decreasing data burstness according to the embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

While the present invention is applicable to all communication systems, it will be described in the context of a mobile communication system. The present invention provides a method of guaranteeing QoS for each service, particularly a method of classifying services into a QoS service and a non-QoS service and dealing with them discriminately. Here, the QoS service is defined as a service requiring QoS, that is, a high-priority service, while the non-QoS service is defined a service not requiring QoS, that is, a low-priority service. Therefore, a dynamic rate control for each service based on the state of a transmission link and a burstness regulation for minimizing data congestion will be described. In accordance with an embodiment of the present invention, a dynamic rate control for a QoS service is carried out in a different manner depending on a dynamic rate state (i.e., a good transmission link state) or a circuit type fixed rate state (i.e., a bad transmission link state). The dynamic rate control ensures a minimum data rate for a QoS service even in a bad transmission link state.

Terms used herein will first be defined. “Data” is data provided for a service and used in the sense of a packet in an Internet Protocol Network or an ATM (Asynchronous Transfer Mode) cell in an ATM system. Therefore, although data is used as a packet, an ATM cell, a frame, or traffic, they have the same meaning. As stated before, “QoS service” is a service requiring QoS, that is, a relatively high-priority service, whereas “non-QoS service” is a service not requiring QoS, that is, a relatively low-priority service among services provided in a system.

“Service” covers voice and data service. Service types are classified as in Table 1 and services are classified according to the classes of subscribers as in Table 2. In Table 1, higher priority levels can be assigned to services in a descending order of service type numbers. Table 2 lists four subscriber classes: premium class subscriber, gold class subscriber, silver class subscriber, and bronze class subscriber. A higher-class subscriber receives more services. Notably, service types and subscriber classes in Table 1 and Table 2, respectively, are merely exemplary. Therefore, the classification is system-dependent.

TABLE 1

| Service Type | Service |
|---|---|
| Service Type No. 1 | Voice |
| Service Type No. 2 | VOD (Voice On-Demand) |
| Service Type No. 3 | File Transfer |
| Service Type No. 4 | MOD (Music On-Demand) |
| Service Type No. 5 | Web Surfing |

TABLE 2

| Subscriber Class | Provided Services |
|---|---|
| Premium Class Subscriber | Voice, VOD, File Transfer, MOD, Web |
| | Surfing |
| Gold Class Subscriber | Voice, File Transfer, MOD, Web |
| | Surfing |
| Silver Class Subscriber | Voice, MOD, Web Surfing |
| Bronze Class Subscriber | Voice, Web Surfing |

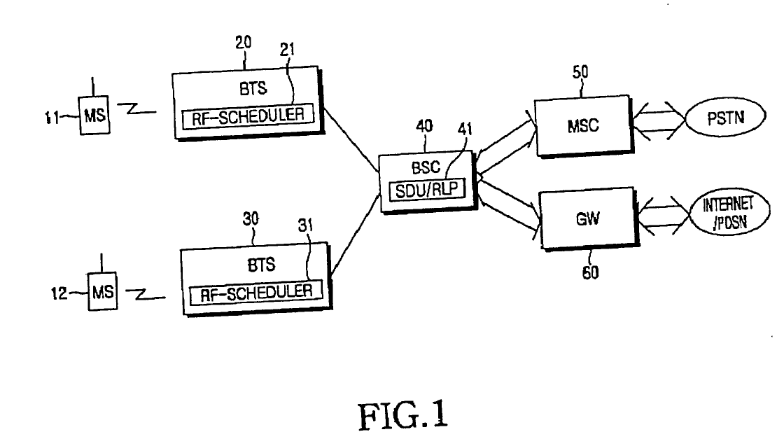

FIG. 1 illustrates a network configuration of a mobile communication system to which the present invention is applied. The mobile communication system supports packet service as well as voice service to mobile subscribers. The structure illustrated in FIG. 1 is a generalized one, and the components are termed depending on which system is used (e.g., IS-2000, WCDMA, UMTS, CDMA2000, 1×EV-DO, GPRS, and 1×EV-DV).

Referring to FIG. 1, the mobile communication system includes MSs 11 and 12, BTSs 20 and 30 connected wirelessly to the MSs 11 and 12, and a BSC 40 connected to the BTSs 20 and 30. The BSC 40 is connected to an MSC 50 and a gateway (GW) 60. The MSC 50 is connected to a PSTN (Public Switched Telephone Network) and the GW 60 is connected to the Internet/PSDN (Packet Serving Data Network). When the MS 11 is connected to the PSTN via the MSC 50 under the control of the BSC 40, a voice service is provided to the MS 11. If the MS 11 is connected to the Internet/PSDN via the GW 60, a data service is provided to the MS 11.

The BTSs 20 and 30 include RF (Radio Frequency) schedulers 21 and 31, respectively, and the BSC 40 includes an SDU (Selection & Distribution Unit)/RLP processor 41. The RF schedulers 21 and 31 enable the BTSs 20 and 30 to use radio resources efficiently and assign the radio resources appropriately to a plurality of users. The SDU processor 41 transmits traffic to a plurality of BTSs and combines the same data received from an MS through a BTS. While the SDU processor 41 may be located in the GW 60, it is assumed that the SDU processor 41 is provided within the BSC 40. The RLP processor 41 converts packets received from the GW 60 in an error control protocol frame structure for transmission to the BTSs 20 and 30. Notably, the BTSs 20 and 30 have limited buffer space for users. Therefore, if the BTSs 20 and 30 receive more traffic than can be accommodated from the BSC 40, they experience traffic loss. To prevent the traffic loss, flow control is performed.

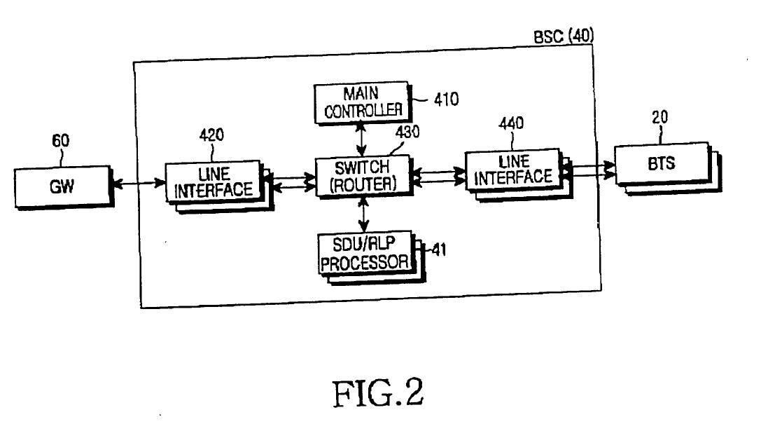

FIG. 2 is a block diagram of the BSC 40 illustrated in FIG. 1. Referring to FIG. 2, the BSC 40 is comprised of a main controller 410, a line interface (or network interface) 420, a switch (or router) 430, and a line interface 440. The main controller 410 provides overall control to the BSC 40. The line interface 420 connects the BSC 40 to the GW 60, and the line interface 440 connects the BSC 40 to the BTS 20. The switch 430 routes traffic within the BSC 40. The SDU processor 41 multiplexes traffic to be transmitted on two links and demultiplexes traffic received on the links at a soft handover. The RLP processor 41 supports radio link error correction.

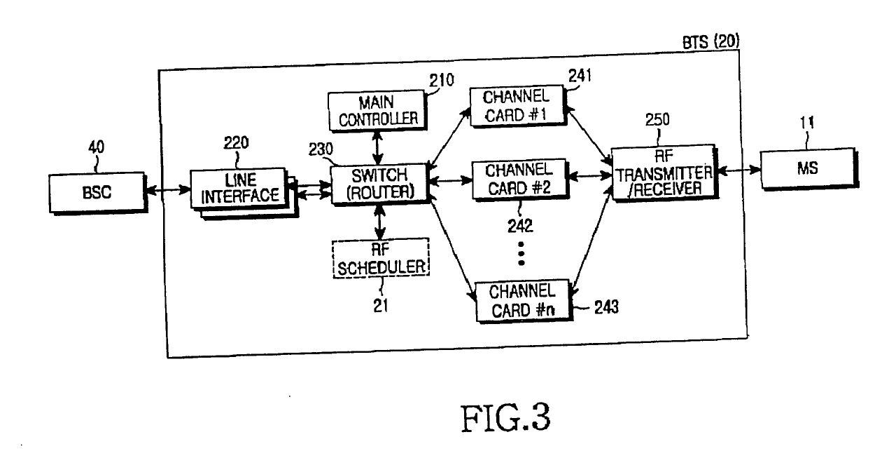

FIG. 3 is a block diagram of the BTS 20 illustrated in FIG. 1. The following description is also applicable to the BTS 30.

Referring to FIG. 3, the BTS 20 includes a main controller 210, a line interface 220, a switch (or router) 230, channel cards 241 to 243, an RF transmitter/receiver 250, and an RF scheduler 21. The main controller 210 provides overall control to the BTS 20. The line interface 220 connects the BTS 20 to the BSC 40. The RF transmitter/receiver 250 exchanges data and control signals with the MS 11. The switch 230 determines a traffic path within the BTS 20. The RF scheduler 21 supports efficient management of radio resources. The RF scheduler 21 may be implemented as an independent processor as shown, or by software within the channel cards 241 to 243.

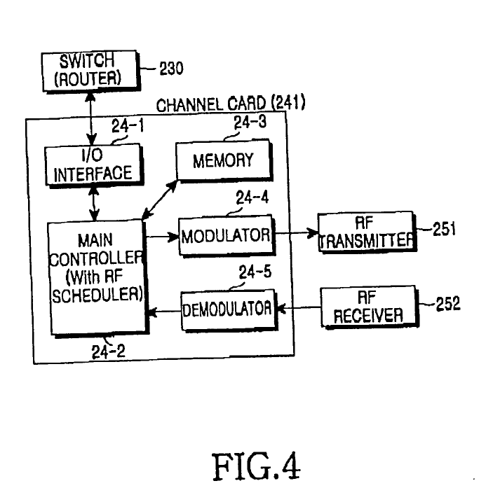

FIG. 4 is a block diagram of the channel card 241. The same description is applicable to the other channel cards 242 and 243. Referring to FIG. 4, the channel card 241 includes an input/output (I/O) interface 24-1, a main controller 24-2, a memory 24-3, a modulator 24-4, and a demodulator 24-5. The I/O interface 24-1 interfaces between the switch 230 and the channel card 241. The modulator 24-4 modulates data and control signals to be transmitted to the MS 11 via the RF transmitter 251 in the RF transmitter/receiver 250. The demodulator 24-5 demodulates data and control signals received from the MS 11 through the RF receiver 252 in the RF transmitter/receiver 250. The memory 24-3 has a buffer for receiving packet data directed to the MS 11 from the BSC 40 and temporarily storing it. The memory 24-3 also stores control information.

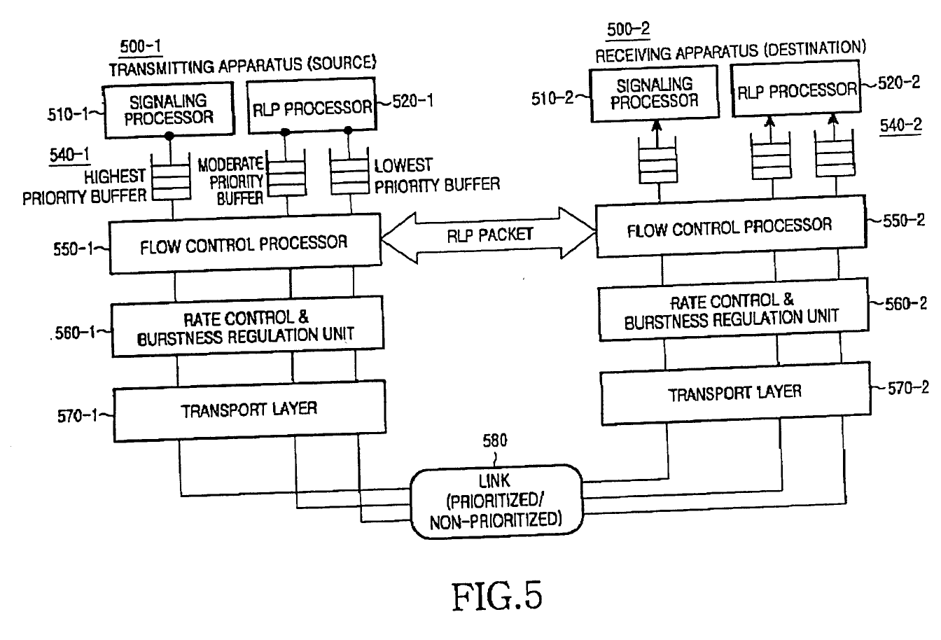

FIG. 5 illustrates a layered protocol structure between a transmitting apparatus and a receiving apparatus when they exchange data by an RLP (Radio Link Protocol) in a communication system according to an embodiment of the present invention. If the communication system is the mobile communication system illustrated in FIG. 1, the transmitter corresponds to the SDU/RLP processor 41 of the BSC illustrated in FIG. 2 and the receiver corresponds to a channel card of the BTS illustrated in FIG. 3.

Referring to FIG. 5, a transmitting apparatus (or a source) 500-1 includes a signaling processor 510-1, an RLP processor 520-1, buffers 540-1, a flow control processor 550-1, a rate control & burstness regulation unit 560-1, and a transport layer 570-1. Similarly, a receiving apparatus (or a destination) 500-2 includes a signaling processor 510-2, an RLP processor 520-2, buffers 540-2, a flow control processor 550-2, a rate control & burstness regulation unit 560-2, and a transport layer 570-2. The transmitting apparatus 500-1 is connected to the receiving apparatus 500-2 via a transmission link 580. The transmission link 580 may be configured as one prioritized link, a plurality of prioritized links, or non-prioritized links.

In the transmitting apparatus 500-1, an RLP frame processed in the signaling processor 510-1 and the RLP processor 520-1 is subject to a flow control in the flow control processor 550-1. For a flow control based on priority, the plurality of buffers 540-1 are provided. As illustrated, the buffers 540-1 include a highest-priority buffer, a moderate-priority buffer, and a lowest-priority buffer. The rate control & burstness regulation unit 560-1 performs a rate control and burstness regulation on the flow-controlled RLP frame. Then the transport layer 570-1 processes the RLP frame into a transmission frame suitable for transmission and transmits it via the link 580.

In the receiving apparatus 500-2, the transport layer 570-2 processes the transmission frame received from the transmitting apparatus 500-1. The rate control & burstness regulation unit 560-2 performs a rate control and burstness regulation on the received RLP frame. Then the RLP frame is subject to a flow control in the flow control processor 550-2. For a flow control based on priority, the plurality of buffers 540-2 are provided. As illustrated, the buffers 540-2 include a highest-priority buffer, a moderate-priority buffer, and a lowest-priority buffer. The flow-controlled RLP frame is processed in the signaling processor 510-2 and the RLP processor 520-2.

As illustrated in FIG. 5, the transmitting apparatus 500-1 and the receiving apparatus 500-2 process data according to service priority. Particularly, services are classified into a QoS service and a non-QoS service and a rate control and burstness regulation is performed for each service according to the state of the transmission link, in order to guarantee QoS for the QoS service. For example, when the transmitting apparatus 500-1 transmits data for a first service and data for a second service having a lower priority than the first service, it guarantees the QoS of the first service. To provide services discriminately, system information illustrated in Table 3 is used for the QoS service and system information illustrated in Table 4 is used for the non-QoS service.

TABLE 3

Service_Flow_Identifier
Required_Minimum_Rate
Allowed_Maximum_Rate
Current_Rate

In Table 3, Service_Flow_Identifier identifies a service. Required_Minimum_Rate is a minimum band required to support the service. Allowed_Maximum_Rate is a maximum rate allowed for the service. Current_Rate is the current data rate of the service. When data congestion does not occur, that is, there are available resources in the system, the service can be provided at the maximum rate. On the other hand, if data congestion occurs, that is, there is a shortage of resources in the system, the minim rate is ensured for the service.

TABLE 4

Service_Flow_Identifier
Required_Starvation_Rate
Current_Rate

In Table 4, Service_Flow_Identifier identifies a service. Required_Starvation_Rate is a minimum rate to be ensured for the service. The Required_Starvation_Rate can be set to a value that allows delivery of signaling messages. Current Rate is the current data rate of the service.

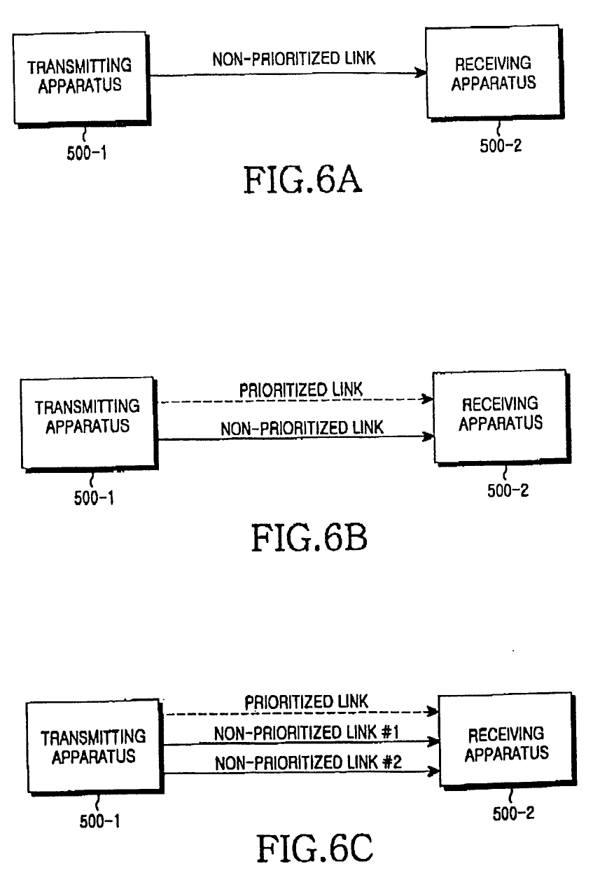

FIGS. 6A, 6B, and 6C illustrate examples of the link 580 between the transmitting apparatus 500-1 and the receiving apparatus 500-2 illustrated in FIG. 5. As illustrated in FIG. 6A, a non-QoS service is provided through a non-prioritized link. While services are provided through the single non-prioritized link in FIG. 6, a plurality of non-prioritized links can be used. A prioritized link can be built as illustrated in FIGS. 6B and 6C. FIGS. 6B and 6C illustrate a single prioritized link and one or more non-prioritized links. Needless to say, a plurality of prioritized links can be constructed depending on system design. For clarity of description, the following description is made on the assumption that transmission links are constructed as illustrated in FIG. 6A or 6B.

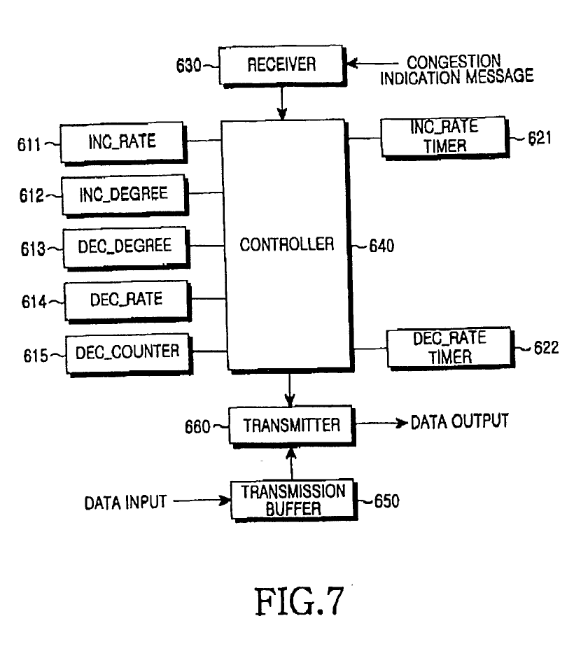

FIG. 7 is a block diagram of a data transmitting apparatus according to the embodiment of the present invention. The data transmitting apparatus transmits data for a first service and data for a second service having a lower priority than the first service, and guarantees the QoS of the first service. Referring to FIG. 7, the data transmitting apparatus includes registers 611 to 614, a counter 615, timers 621 and 622, a receiver 630, a controller 640, a transmission buffer 650, and a transmitter 660. The register 611 stores a period INC_RATE after which the data rate of a service is increased. The register 612 stores a rate increment INC_DEGREE by which the data rate is increased. The register 613 stores a rate decrement DEC_DEGREE by which the data rate is decreased. The register 614 stores a period DEC_RATE after which a service is transitioned from a circuit type fixed rate state to a dynamic rate state. The counter 615 counts a parameter value by which it is determined whether to decrease the data rate upon receipt of one Congestion Indication Message or a plurality of Congestion Indication Messages at the receiver 630. The timer 621 is activated or deactivated under the control of the controller 640 and provides a predetermined time value. The time value determines the value of the register 611, INC_RATE.

The receiver 630 receives a Congestion Indication Message requesting data congestion control from the receiving apparatus 500-2 illustrated in FIG. 5. Upon receipt of congestion indication information or a congestion indicator from the transmitting apparatus 500-1, the receiving apparatus 500-2 transmits the Congestion Indication Message. The congestion indication information is, for example, an EFCI (Explicit Forward Congestion Indicator) in an ATM communication system. As is known in the art, the EFCI is set to 1 if the size of data transmitted for a predetermined time period is equal to or greater than a threshold, and to 0 if the data size is less than the threshold. Generation of the congestion indication information will not be described here in detail. The transmission buffer 650 stores transmission data. As illustrated in FIG. 5, a plurality of transmission buffers can be used according to service priorities.

The controller 640 receives the values of the registers 611 to 614, the count of the counter 615, and time values set in the timers 621 and 622. It also receives from the receiver 630 information indicating whether a Congestion Indication Message has been received. Using the received information, the controller 640 determines the data rate of transmission data. For example, the controller 640 determines the data rate of a QoS service in a dynamic rate state (mode) or a circuit type fixed rate state (mode). In the dynamic rate state, the controller 640 dynamically controls the data rate of a service. In the circuit type fixed rate state, the controller 640 determines the data rate of a service as its required minimum rate. The controller 640 also determines the data rate of a non-QoS service in the dynamic rate state.

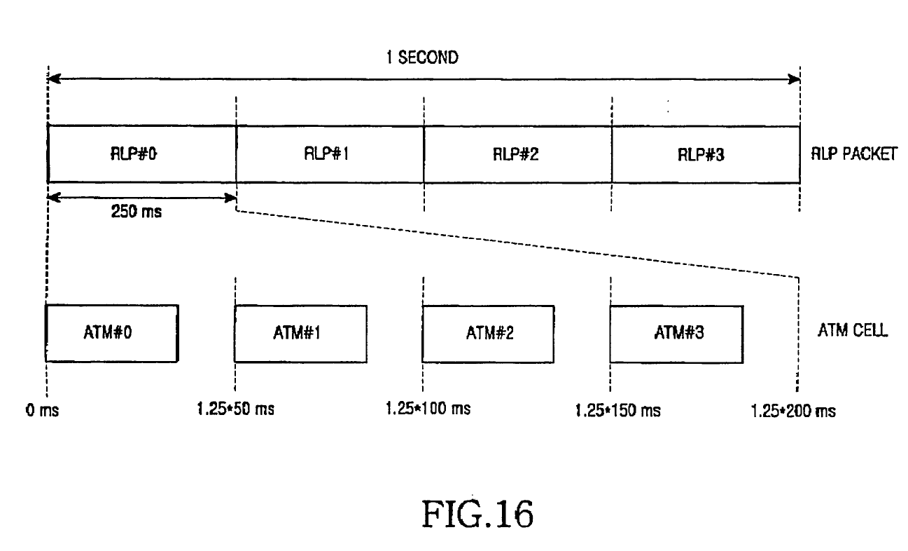

The transmitter 660 transmits buffered data at a data rate determined by the controller 640. The transmitter 660 also regulates data burstness by segmenting transmission data into a plurality of transport units of a predetermined size (e.g., ATM cells) and transmitting each transport unit at a predetermined interval. The burstness regulation will be described later with reference to FIG. 16.

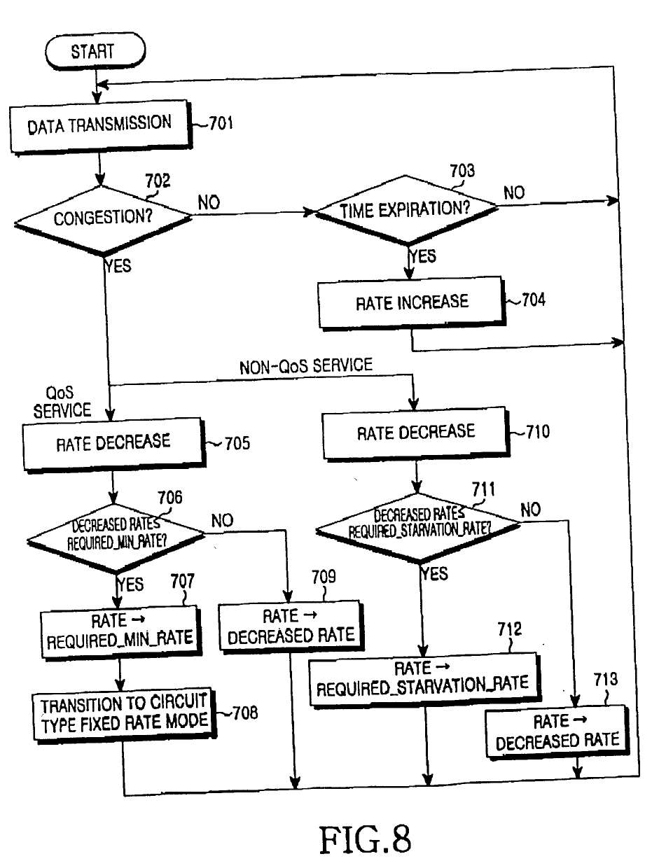

FIG. 8 is a flowchart illustrating a dynamic rate control operation according to the embodiment of the present invention. The dynamic rate control operation is carried out in the transmitting apparatus illustrated in FIG. 5, particularly in the transmitting apparatus of FIG. 7. Referring to FIG. 8, data is transmitted to provide a service in step 701. An initial data rate is set a required minimum rate if the service is a QoS service, whereas it is set a required starvation rate if the service is a non-QoS service. In step 702, it is determined whether data congestion has occurred by checking whether a Congestion Indication Message has been received. If data congestion has not occurred, it is determined whether a predetermined time period has expired in step 703. Upon expiration of the time period, the data rate of the service is increased in step 704. Otherwise, if data congestion has occurred, steps 705 to 709 for a QoS service or steps 710 to 713 for a non-QoS service are performed.

In a QoS service, the data rate is decreased in step 705. The decreased rate is compared with the required minimum rate in step 706. If the decreased rate is equal to or less than the required minimum rate, the data rate of the service is determined as its required minimum date in step 707. Then a data rate control mode is transitioned to a circuit type fixed rate mode in step 708. On the other hand, if the decreased rate is greater than the required minimum rate in step 706, the data rate of the service for the next period is determined as the decreased rate in step 709.

In a non-QoS service, the data rate is decreased in step 710. The decreased rate is compared with the required starvation rate of the service in step 711. If the decreased rate is equal to or less than the required starvation rate, the data rate of the service is determined as its required starvation date in step 712. If the decreased rate is greater than the required starvation rate in step 710, the data rate of the service for the next period is determined as the decreased rate in step 713.

After step 707, 709, 712, or 713, data is transmitted at the determined rate in step 701. In the circuit type fixed rate mode, data for the QoS service is transmitted at the required minimum rate. Thus the required minimum rate is ensured for the QoS service even when data congestion occurs.

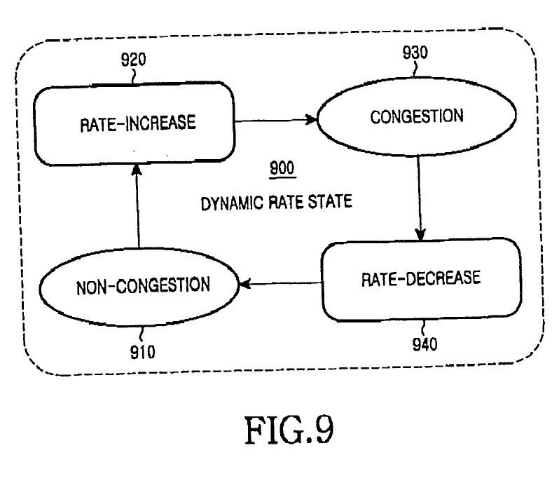

FIG. 9 depicts a data rate control for a non-QoS service according to the embodiment of the present invention. Referring to FIG. 9, the data rate control is performed for the non-QoS service in a dynamic rate state 900. The dynamic rate state 900 includes a non-congestion state 910, a rate increase state 920, a congestion state 930, and a rate decrease state 940. The non-congestion state 910 is transitioned to the rate increase state 920. If data congestion occurs in the rate increase state 920, the rate increase state 920 is transitioned to the congestion state 930. Then the congestion state 930 is in turn transitioned to the rate decrease state 940.

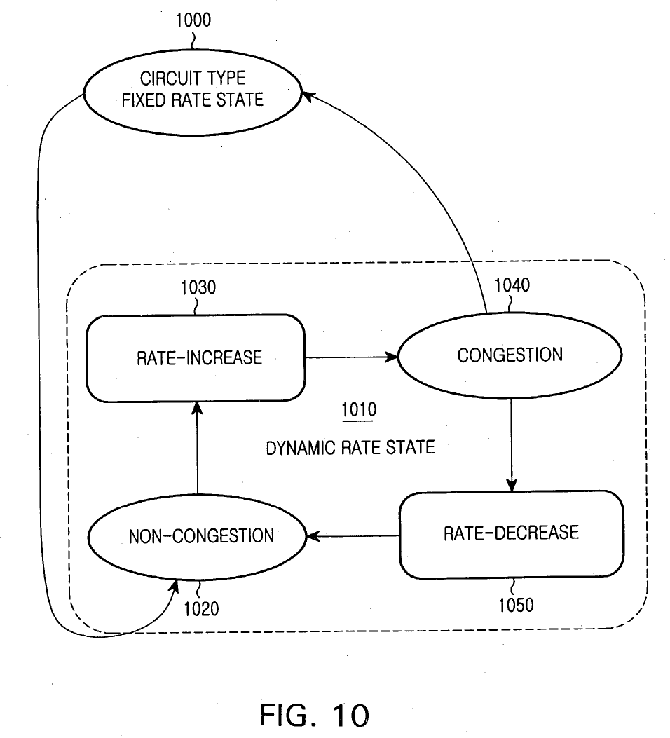

FIG. 10 depicts a data rate control for a QoS service according to the embodiment of the present invention. Referring to FIG. 10, the data rate control is performed for the QoS service in the dynamic rate state 1010 and in a circuit type fixed rate state 1000. The dynamic rate state 1010 includes the non-congestion state 1020, the rate increase state 1030, the congestion state 1040, and the rate decrease state 1050. The non-congestion state 1020 is transitioned to the rate increase state 1030. If data congestion occurs in the rate increase state 1030, the rate increase state 1030 is transitioned to the congestion state 1040. Then the congestion state 1040 is in turn transitioned to the rate decrease state 1050.

If data congestion becomes severe in the dynamic rate state 1010, the dynamic rate state 1010 is transitioned to the circuit type fixed rate state 1000. It can be said that data congestion is severe when a data rate decreased due to the data congestion is equal to or less than a required minimum rate. In the circuit type fixed rate state 1000, data is transmitted at the required minimum rate. The transition from the circuit type fixed rate state 1000 to the dynamic rate state 1010 occurs when the DEX_RATE timer 622 expires.

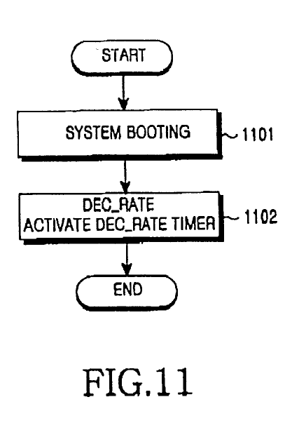

FIG. 11 is a flowchart illustrating an initial operation in the communication system according to the embodiment of the present invention. Referring to FIG. 11, the system is booted in step 1101. In step 1102, parameters are set, or to initial values, particularly the DEC_RATE timer 622 illustrated in FIG. 7 is activated.

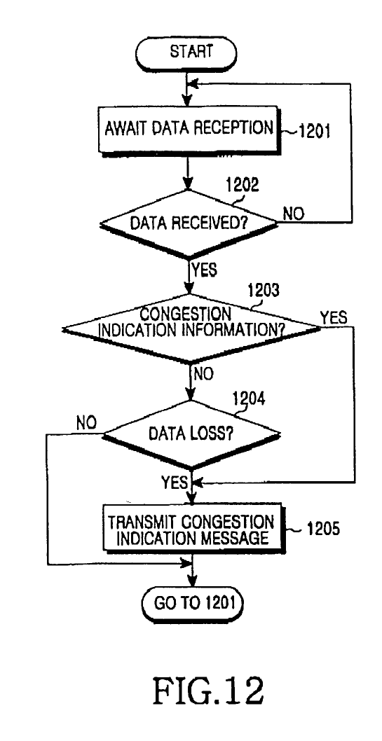

FIG. 12 is a flowchart illustrating an operation for generating a Congestion Indication Message in a receiving apparatus of the communication system according to the embodiment of the present invention. Referring to FIG. 12, a receiving apparatus awaits receipt of data (a packet or a cell) from a transmitting apparatus in step 1201. Upon receipt of data in step 1202, it is determined whether the received data includes a congestion indicator bit or congestion indication information in step 1203. If it does, the receiving apparatus transmits a Congestion Indication Message to the transmitting apparatus, requesting congestion control in step 1205. Even if the received data does not include the congestion indication information, when data loss is detected in step 1204, the Congestion Indication Message is transmitted to the transmitting apparatus in step 1205. If the congestion indicating information is not included in the received data, or if data loss is not detected, the received data is processed normally.

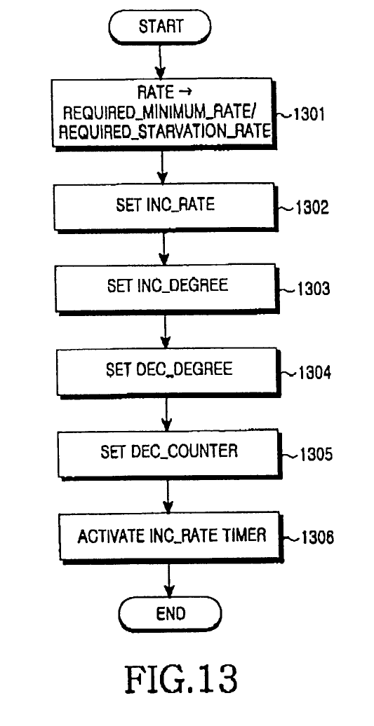

FIG. 13 is a flowchart illustrating an initial data transmitting operation in the transmitting apparatus of the communication system according to the embodiment of the present invention. This operation is performed in the controller 640 illustrated in FIG. 7. Referring to FIG. 13, the controller 640 sets an initial data rate to a required minimum rate in a QoS service and to a required starvation rate in a non-QoS service in step 1301. In steps 1302 to 1305, the controller 640 sets INC_RATE in the register 611, INC_DEGREE in the register 612, DEC DEGREE in the register 613, and DEC_COUNTER in the counter 615. A system operator can optimize these parameters in advance. In step 1306, the controller 640 activates the INC_RATE timer 622. At an initial data transmission, the transmitting apparatus is set to a dynamic rate mode.

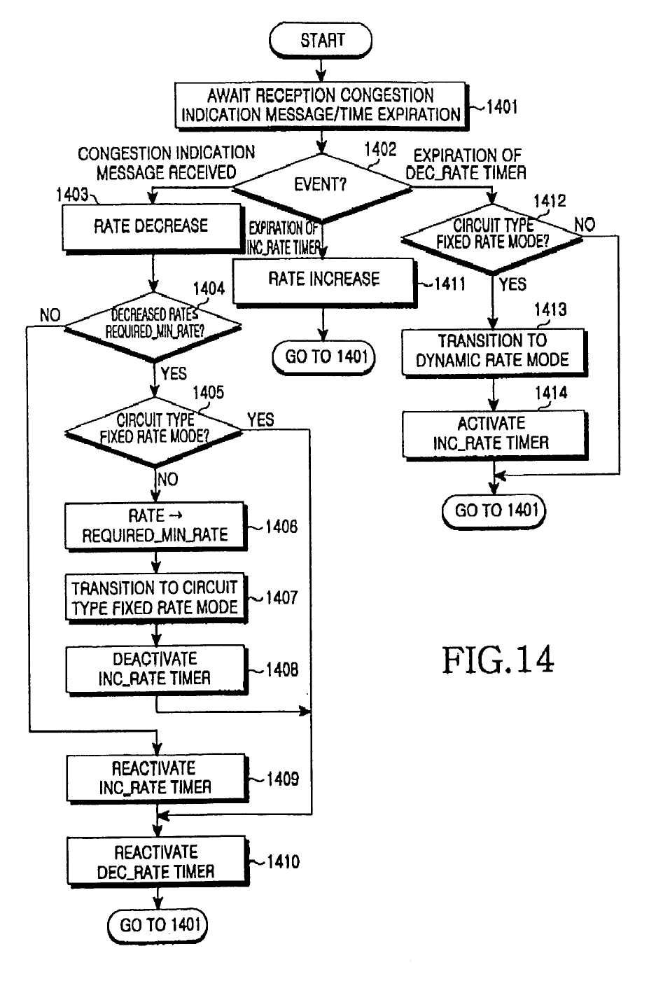

FIG. 14 is a flowchart illustrating a data rate control operation for a QoS service in the transmitting apparatus of the communication system according to the embodiment of the present invention. This operation is performed in the controller 640 illustrated in FIG. 7. Referring to FIG. 14, the controller 64 awaits receipt of a Congestion Indication Message or expiration of the timer 621 or 622 in step 1401. If any of the three events occurs in step 1402, the controller 640 operates correspondingly.

Upon generation of the first event, that is, when a Congestion Indication Message is received, which implies that the current data rate is to be decreased, steps 1403 to 1410 are performed. Upon receipt of the Congestion Indication Message, the controller 640 decreases the current data rate by a predetermined decrement in step 1403. For example, the current data rate is decreased by half or by the value DEC_DEGREE of the register 613. Alternatively, the decrement can be a great value. In step 1404, the controller 640 compares the decreased rate with the required minimum rate of a service. If the decreased rate is greater than the required minimum rate, the controller 640 reactivates the INC_RATE timer 621 in step 1409. Then the procedure goes to step 1410.

On the other hand, if the decreased rate is equal to or less than the required minimum rate, the controller 640 determines whether a current rate mode is a circuit type fixed rate mode in step 1405. In the circuit type fixed rate mode, the controller 640 reactivates the DEC_RATE timer 622 in step 1410. In a dynamic rate mode, the controller 640 sets the data rate of the service to its required minimum rate for data transmission in the next period in step 1406. In step 1407, the controller 640 transitions the data rate mode to the circuit type fixed rate mode. The controller 640 deactivates the INC_RATE timer 621 in step 1408, reactivates the DEC_RATE timer 622 in step 1410, and then returns to step 1401.

Upon generation of the second event, that is, when the INC_RATE timer 621 expires, the controller 640 increases the current data rate by the value INC_RATE of the register 612 in step 1411 and returns to step 1401.

Upon generation of the third event, that is, when the DEC_RATE timer 622 expires, which implies that the current circuit type fixed rate mode is transitioned to the dynamic rate mode, the controller 640 determines whether the current rate mode is the circuit type fixed rate mode in step 1412. In the dynamic rate mode, the controller 640 returns to step 1401. In the circuit type fixed rate mode, the controller 640 transitions the service from the circuit type fixed rate mode to the dynamic rate mode in step 1413. In step 1414, the controller 640 activates the INC_RATE timer. Then the controller 640 returns to step 1401.

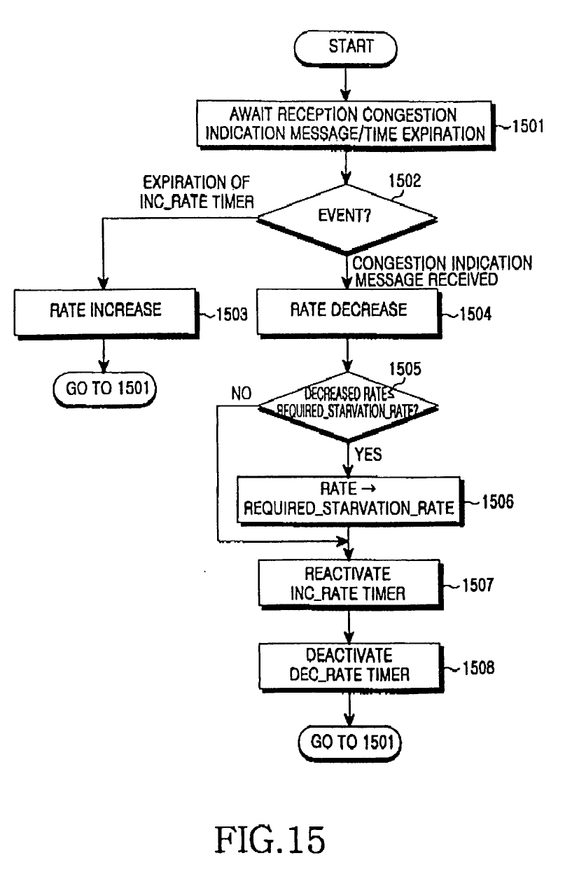

FIG. 15 is a flowchart illustrating a data rate control operation for a non-QoS service in the transmitting apparatus of the communication system according to the embodiment of the present invention. This operation is performed in the controller 640 illustrated in FIG. 7.

Referring to FIG. 15, the controller 64 awaits receipt of a Congestion Indication Message or expiration of the timer 621 in step 1501. If either of the two events occurs in step 1502, the controller 640 operates correspondingly.

When a Congestion Indication Message is received, which implies that the current data rate is to be decreased, steps 1504 to 1508 are performed. Upon receipt of the Congestion Indication Message, the controller 640 decreases the current data rate by a predetermined decrement in step 1504. For example, the current data rate is decreased by half or by the value DEC_DEGREE of the register 613. Or the decrement can be a great value. In step 1505, the controller 640 compares the decreased rate with the required starvation rate of a service. If the decreased rate is greater than the required starvation rate, the controller 640 reactivates the INC_RATE timer 621 in step 1507. Then the procedure goes to step 1508. On the other hand, if the decreased rate is equal to or less than the required starvation rate, the controller 640 sets the data rate of the service to the minimum starvation rate for data transmission in the net period in step 1506. The controller 640 reactivates the INC_RATE timer 621 in step 1507 and reactivates the DEC_RATE timer 622 in step 1508. Then the controller 640 returns to step 1501.

When the INC_RATE timer 621 expires, which implies that the current data rate is to be increased, the controller 640 increases it by the value INC_RATE of the register 612 in step 1503 and returns to step 1501.

As described above, burstness regulation is performed to reduce the data burstness for data transmission (ATM cell or IP packet transmission) at a determined data rate. The following description is made on the assumption that a data rate control is performed on an ATM cell basis in an ATM system. The same thing occurs in an IP network. In this case, a data rate control is performed on an IP packet basis. Considering data burstness regulation, the transmission interval of ATM cells and the number of ATM cells transmittable during the transmission interval will be described.

Referring to FIGS. 1 to 5, the SDU/RLP processor 41 of FIG. 1 (i.e., the RLP processor 520-1 in FIG. 5) transmits data in ATM cells on a virtual channel (VC). The SDU/RLP processor 41 stores RLP packets to be transmitted in the transmission buffers 540-1 according to their priorities. To minimize the burstness of backhaul, the SDU/RLP processor 41 transmits buffered RLP packets in the units of ATM cells. The SDU/RLP processor 41 determines the transmission interval TX_interval of ATM cells by

TX_intervl=(y, x), n (1)

where y indicates seconds in the denominator of a required minimum rate, x indicates the number of bits expressed as the number of RLP packets in the numerator of the required minimum rate, and n is the number of ATM cells in one RLP packet.

The SDU/RLP processor 41 basically transmits one ATM cell during the transmission interval. If the transmission interval is less than a minimum cell transmission interval unit (e.g., 1.25 ms) of the SDU/RLP processor 41, the SDU/RLP processor 41 sets the transmission interval to 1.25 ms and transmits two cells during the transmission interval.

FIG. 16 illustrates an ATM cell transmission with data burstness considered according to the embodiment of the present invention. Referring to FIG. 16, one RLP frame includes four RLP packets RLP #0, RLP #1, RLP #2, and RLP #3 in one unit time (1 second). Thus, each RLP packet has a time span of 250 ms and is transmitted in the units of ATM cells after burstness regulation. That is, each RLP packet is segmented into a plurality of transport units of a predetermined size (four ATM cells) and the ATM cells are transmitted at a predetermined transmission interval (1.25 ms). Therefore, data burstness is relieved and data congestion is prevented.

In accordance with the present invention, services are classified into a QoS service and a non-QoS service. The QoS service and the non-QoS service are discriminately provided in a communication system supporting data service. Thus, the quality of the QoS service is guaranteed. Furthermore, a dynamic data rate control is performed based on the state of transmission links to thereby avoid data congestion. By prioritizing the transmission links, the quality of the QoS service is guaranteed even when data congestion occurs. In addition, burstness regulation is performed for transmission data, thereby minimizing a congestion period.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A data transmitting method for guaranteeing a QoS (Quality of Service) of a first service in a transmitting apparatus of a communication system in which the transmitting apparatus transmits a data for a first service and a data for a second service having a lower priority than the first service, and a receiving apparatus receives the data from the transmitting apparatus, the method comprising the steps of:
decreasing a data rate of the first service for a first period by a first predetermined value upon receipt of a Congestion Indication Message from the receiving apparatus;
transmitting the data for the first service during a second period at the decreased data rate if the decreased data rate is greater than a required minimum rate; and
transmitting the data for the first service during the second period at the required minimum rate if the decreased data rate is equal to or less than the required minimum rate.

2. The data transmitting method of claim 1, wherein the required minimum rate is fixed as a data rate used for transmitting the data if the decreased data rate is equal to or less than the required minimum rate.

3. The data transmitting method of claim 1, wherein the transmitted data is RLP (Radio Link Protocol) packet data.

4. The data transmitting method of claim 3, wherein the RLP packet data is segmented into a plurality of transport units of a predetermined size and each of the transport units is transmitted at a predetermined interval.

5. The data transmitting method of claim 4, wherein the transport unit is an ATM (Asynchronous Transfer Mode) cell.

6. The data transmitting method of claim 1, further comprising the steps of:
decreasing a data rate of the second service for the first period by a second predetermined value upon receipt of the Congestion Indication Message from the receiving apparatus;
transmitting the data for the second service during the second period at the decreased data rate if the decreased data rate is greater than a predetermined required starvation rate; and
transmitting the data for the second service during the second period at the required starvation rate if the decreased data rate is equal to or less than the required starvation rate.

7. A data transmitting apparatus for guaranteeing a QoS (Quality of Service) of a first service in a communication system in which the data transmitting apparatus transmits a data for a first service and a data for a second service having a lower priority than the first service, and a receiving apparatus receives the data from the transmitting apparatus, the apparatus comprising:
a receiver for receiving a Congestion Indication Message from the receiving apparatus;
a controller for decreasing a data rate of the first service for a first period by a first predetermined value in response to the Congestion Indication Message; and
a transmitter for, under the control of the controller, transmitting the data for the first service during a second period at the decreased data rate if the decreased data rate is greater than a required minimum rate, and transmitting the data for the first service during the second period at the required minimum rate if the decreased data rate is equal to or less than the required minimum rate.

8. The data transmitting apparatus of claim 7, wherein the required minimum rate is fixed as a data rate used for transmitting the data if the decreased data rate is equal to or less than the required minimum rate.

9. The data transmitting apparatus of claim 7, wherein the transmitted data is RLP (Radio Link Protocol) packet data.

10. The data transmitting apparatus of claim 9, wherein the transmitter segments the RLP packet data into a plurality of transport units of a predetermined size and transmits each of the transport units at a predetermined interval.

11. The data transmitting apparatus of claim 10, wherein the transport unit is an ATM (Asynchronous Transfer Mode) cell.

12. The data transmitting apparatus of claim 7, wherein the controller decreases a data rate of the second service for the first period by a second predetermined value upon receipt of the Congestion Indication Message requesting data congestion control from the receiving apparatus.

13. The data transmitting apparatus of claim 12, wherein the transmitter, under the control of the controller, transmits the data for the second service during the second period at the decreased data rate if the decreased data rate is greater than a required starvation rate, and transmits the data for the second service during the second period at the required starvation rate if the decreased data rate is equal to or less than the required starvation rate.

14. A data transmitting method for guaranteeing a QoS (Quality of Service) of a first service in a transmitting apparatus of a communication system in which the transmitting apparatus transmits a data for a first service and a data for a second service having a lower priority than the first service, and a receiving apparatus receives the data from the transmitting apparatus, the method comprising the steps of:
setting an initial data rate of the first service to a minimum rate required by the QoS of the first service and transmitting the data for the first service at the set initial data rate during an initial transmission period;
increasing the initial data rate of the first service by a first predetermined value and transmitting the data for the first service at the increased data rate during a first transmission period, a predetermined time after the initial transmission period; and
decreasing the increased data rate by a second predetermined value upon receipt of a Congestion Indication Message from the receiving apparatus and transmitting the data for the first service at the decreased data rate or the minimum rate during a second transmission period.

15. The data transmitting method of claim 14, wherein the step of transmitting the data during the second transmission period comprises the steps of:
decreasing the increased data rate by the second value;
comparing the decreased data rate with the minimum rate;
transmitting the data for the first service at the decreased data rate if the decreased data rate is greater than the minimum rate; and
transmitting the data for the first service at the minimum rate if the decreased data rate is equal to or less than the minimum rate.

16. The data transmitting method of claim 14, wherein the transmitted data is RLP (Radio Link Protocol) packet data.

17. The data transmitting method of claim 16, wherein the RLP packet data is segmented into a plurality of transport units of a predetermined size and each of the transport units is transmitted at a predetermined interval.

18. The data transmitting method of claim 17, wherein the transport unit is an ATM (Asynchronous Transfer Mode) cell.
